(19) United States
(12) Patent Application Publication
(10) Pub. No.: US 2011/0062868 A1
(43) Pub. Date: Mar. 17, 2011

(54) High luminous output LED lighting devices

(76) Inventors: Thomas W. Domagala, Cottage Grove, MN (US); Steven C. Furlong, Maple Grove, MN (US)

(21) Appl. No.: 12/807,720

(22) Filed: Sep. 13, 2010

Related U.S. Application Data
(60) Provisional application No. 61/276,447, filed on Sep. 14, 2009.

(51) Int. Cl. H01K 1/62

(52) U.S. Cl. 315/32

(57) ABSTRACT

A white light LED-based lighting device configured for direct replacement of existing incandescent lighting devices is provided. The white light LED-based lighting device comprises a group of solid state light emitting diodes, electronics to activate the light emitting diodes, said solid state light emitters mounted on a planar surface, reflective optics located at the output of the lighting device, the planar surface with solid state light emitters located at the entrance to said reflective optics, and an encapsulating housing configured for direct replacement of existing incandescent lighting devices.

### CROSS-REFERENCE TO RELATED APPLICATIONS

This application claims the benefit of U.S. Provisional Patent Application No. 61/276,447, filed Sep. 14, 2009, the disclosure of which is incorporated herein by reference in its entirety.

### FIELD OF THE INVENTION

The present invention is directed generally to lighting devices, and more particularly to white light LED-based lighting devices with high luminous output configured for direct lumen-for-lumen replacement of existing incandescent lighting devices.

### BACKGROUND

Energy conservation, in all its varied forms, has become a national priority of the United States as well as the rest of the world, from both the practical point of view of limited natural resources and recently as a security issue to reduce our dependence on foreign oil. A large proportion (some estimates are as high as one third) of the electricity used in residential homes in the United States each year goes to lighting. The percentage is much higher for businesses, street lights, amongst other varied items. Accordingly, there is an ongoing need to provide lighting, which is more energy efficient. It is well known that incandescent light bulbs are very energy inefficient light sources—about ninety percent of the electricity they consume is released as heat rather than light. This heat adds to the cooling load of a system during cooling season. In heating season the cost per BTU of heat that the lights give off is typically more expensive than the cost per BTU of the main heat source. The heat that is given off by the lighting also can cause “over shooting” of the desired temperature which waists energy and makes the space feel uncomfortable. Fluorescent light bulbs are more efficient than incandescent light bulbs (by a factor of about four) but are still quite inefficient as compared to solid state light emitters, such as light emitting diodes (LED's).

In addition, as compared to the normal lifetimes of solid state light emitters, incandescent light bulbs have relatively short lifetimes, i.e., typically in the range of 750 to 2000 hours. Fluorescent bulbs have longer lifetimes (e.g., 8,000 to 20,000 hours), but provide less favorable color reproduction and contain hazardous mercury. In dramatic comparison, the lifetime of light emitting diodes, for example, can generally be measured in decades (approximately 50,000 hrs or more).

One established method of comparing the output of different light generating sources has been coined color reproduction. Color reproduction is typically given numerical values using the so-called Color Rendering Index (CRI). CRI is a relative measurement of how the color rendition of an illumination system compares to that of a blackbody radiator, i.e., it is a relative measure of the shift in surface color of an object when lit by a particular lamp. The CRI equals 100 if a set of test colors being illuminated by an illumination system are the same as the results as being irradiated by a blackbody radiator. Daylight has the highest CRI (100), with incandescent bulbs being relatively close (about 95), and fluorescent lighting being less accurate (70 to 85). Certain types of specialized lighting devices have relatively low CRI's (e.g., mercury vapor or sodium, both as low as about 40 or even lower). Sodium lights are used, for example, to light highways and surface streets. Driver response time, however, significantly decreases with lower CRI values (for any given brightness, legibility decreases with lower CRI).

A practical issue faced by conventional lighting systems is the need to periodically replace the lighting devices (e.g., light bulbs, fixtures, ballasts, etc.). Such issues are particularly pronounced where access is difficult (e.g., vaulted ceilings, bridges, high buildings, traffic tunnels) and/or where change-out costs are extremely high. The typical lifetime of conventional fixtures is about 20 years, corresponding to a light-producing device usage of at least about 44,000 hours (based on a typical usage of 6 hours per day for 20 years). In contrast, light-producing device lifetimes are typically much shorter, thus creating the need for periodic change-outs. The potential number of residential homes that may be candidates for these periodic change-outs of the traditional incandescent lighting systems, including base fixtures and lamps themselves, may be extremely large and represent an attractive commercial enterprise. For example, in the United States alone new residential home construction has average approximately 1.5 million dwellings per year over the last 30 years running. Including older homes built before 1979, this represents at least 100 million residential dwellings that are candidates for potential upgrades to more energy efficient LED-based lighting systems.

Accordingly, for these and other reasons, efforts have been ongoing to develop ways by which solid state light emitters can be used in place of incandescent lights, fluorescent lights and other light-generating devices in a wide variety of applications. In addition, where solid state light emitters are already being used, efforts are ongoing to provide solid state light emitter-containing devices which have improved energy efficiency, color rendering index (CRI), contrast, and useful lifetime.

Light emitting diodes are well-known semiconductor devices that convert electrical current into light. A wide variety of light emitting diodes are used in increasingly diverse fields for an ever-expanding range of purposes. More specifically, light emitting diodes are semiconducting devices that emit light (ultraviolet, visible, or infrared) when an electrical potential difference is applied across a p-n junction structure. There are a number of well-known ways to make light emitting diodes and many associated structures, and the present invention can employ any such manufacturing technique.

The commonly recognized and commercially available light emitting diodes that are sold, for example, in electronics stores typically represents a “packaged” device made up of a number of parts. These packaged devices typically include a semiconductor-based light emitting diode and a means to encapsulate the light emitting diode. As is well known, a light emitting diode produces light by exciting electrons across the band gap between a conduction band and a valence band of a semiconductor active (light-emitting) layer. The electron transition generates light at a wavelength that depends on the band-gap energy difference. Thus, the color of the light (usually expressed in terms of its wavelength) emitted by a light emitting diode depends on the semiconductor materials embedded in the active layers of the light emitting diode.

Although the development of solid state light emitters, e.g., light emitting diodes, has in many ways revolutionized the lighting industry, some of the characteristics of solid state light emitters have presented challenges, some of which have not yet been fully met. For example, the emission spectrum of any particular light emitting diode is typically concentrated around a single wavelength (as dictated by the light emitting diode's composition and structure), which is desirable for some applications, but not desirable for others, e.g., for providing lighting, given that such an emission spectrum typically provides a very low CRI.

Because light that is perceived as white is necessarily a blend of light of two or more colors (or wavelengths), no single light emitting diode can produce white light. “White light” emitting devices have been produced which have a light emitting diode structure comprising individual red, green and blue light emitting diodes mounted on a common substrate. Other “white light” emitting devices have been produced which include a light emitting diode which generates blue light and a luminescent material (typically, a phosphor) that emits yellow light in response to excitation by the blue LED output, whereby the blue and the yellow light, when appropriately mixed, produce light that is perceived by the human eye as white light. A wide variety of luminescent materials are well-known and available to persons of skill in the art. For example, a phosphor is a luminescent material that emits a responsive radiation (typically visible light) when excited by a source of exciting radiation. In most instances, the responsive radiation has a wavelength, which is typically longer, than the wavelength of the exciting radiation. Other examples of luminescent materials include day glow tapes and inks, which glow in the visible spectrum upon illumination by ultraviolet light. Luminescent materials can be categorized as being down-converting, i.e., a material which converts photons to a lower energy level (longer wavelength) or up-converting, i.e., a material which converts photons to a higher energy level (shorter wavelength). Inclusion of luminescent materials in LED devices has typically been accomplished by adding the luminescent materials to a clear plastic encapsulating material (e.g., epoxy-based or silicone-based material).

As noted above, “white LED lights” (i.e., lights which are perceived as being white or near-white by the human eye) have been investigated as potential replacements for white light incandescent lamps. A representative example of a white LED light includes a package of a blue light emitting diode chip, made of gallium nitride (GaN), coated with a phosphor such as Yttrium Aluminum Garnet (YAG). In such an LED light, the blue light emitting diode chip produces a blue emission and the phosphor produces a yellow fluorescence on adsorbing that blue emission. For instance, in some designs, white light emitting diodes are fabricated by forming a ceramic phosphor layer on the output surface of a blue light-emitting semiconductor light emitting diode. Part of the blue rays emitted from the light emitting diode pass through the phosphor, while another part of the blue rays emitted from the light emitting diode chip are absorbed by the phosphor, which becomes excited and emits a yellow ray. The part of the blue light emitted by the light emitting diode, which is transmitted through the phosphor, is mixed with the yellow light generated by the phosphor. The human eye perceives the mixture of blue and yellow light as white light.

In another type of LED lamp, a light emitting diode chip that emits an ultraviolet ray which is absorbed by a phosphor material that produces red (R), green (G) and blue (B) light rays. In such an “RGB LED lamp”, the ultraviolet rays that have been radiated from the light emitting diode excites the phosphor, causing the phosphor to emit red, green and blue light rays which, when mixed, are perceived by the human eye as white light. Consequently, white light can also be obtained as a mixture of these light rays also.

Designs have been realized in which existing LED's and other electronics are assembled into an integrated housing fixture. In such designs, an LED or plurality of LED's are mounted on a circuit board encapsulated within the housing fixture, and a heat sink is typically mounted to the exterior surface of housing fixture to dissipate heat generated from within the device, the heat being generated by inefficient AC-to DC conversion from with the device. Although devices of this type can generate white light by any of the means described above, their external geometry typically does not permit direct functional replacement of existing incandescent lighting systems currently installed in residential homes. For example, one such prior art device is described in the CREE Lighting Fixtures Inc. catalog as part number LR6. The LR6 embodiment includes an encapsulated LED structure with an external heat sink assembly integrated as part of a thermal management system. The necessity of an external heat sink assembly in conjunction with an integrated thermal management system adds significant cost to the device as compared to equivalent light output off-the-shelf incandescent devices. In addition, the incorporation of the external heat sink assembly adds significant weight to the device as well as yields an overall external geometry to the lamp which is cylindrical in nature, not at all similar to the familiar incandescent lamps, which in itself may be an impediment to market acceptance to the average home owner envisioning a direct swap-out.

In addition to the above drawbacks, even more importantly, currently available LED-based lighting devices do not appear to generate sufficient light output, at a cost competitive price, to be a direct lumen-for-lumen replacement for incandescent lighting devices. This may be the single biggest reason for current poor market penetration of white-light LED lighting devices into the residential market place.

Given this, there is a need for a cost competitive LED-based white light device capable of direct lumen-for-lumen replacement of existing incandescent lighting devices which can be installed directly by the homeowner without the need of unwanted masonry work and without the additional cost of a licensed technician to perform such an installation.

### SUMMARY OF THE INVENTION

Generally, the present invention is directed to lighting devices, and more particularly to white light LED-based lighting devices with high luminous output configured for direct lumen-for-lumen replacement of existing incandescent lighting devices.

One embodiment of the present invention describes a lighting device for generating diffuse white light comprising a group of solid state light emitters, electronics to activate the solid state light emitters by converting 120 volt 60 cycles per second alternating current to a steady state direct current (DC) voltage, the solid state light emitters mounted on a planar surface, reflective optics located at the output of the lighting device, the planar surface with solid state light emitters located at the entrance to the reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a group of solid state light emitters, said group including light emitting diodes energized by a direct current (DC) voltage, a housing configured to supply a direct current (DC) voltage to the base of the lighting device, electronics to activate the solid state light emitters, wherein the electronics may be configured as a DC-to-DC converter to apply the appropriate DC voltage(s) and drive currents to the DC driven LEDs, the solid state light emitters mounted on a planar surface, reflective optics located at the output of the lighting device, the planar surface with solid state light emitters located at the entrance to the reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a group of solid state light emitters, said group including light emitting diodes energized by an alternating current (AC) drive voltage, a housing configured to supply a 120 volt AC (60 Hertz) input signal to the base of the lighting device, electronics to activate the solid state light emitters, wherein the electronics may be configured as a AC-to-AC converter to apply the appropriate AC voltage(s) and drive currents to the AC driven LEDs, the solid state light emitters mounted on a planar surface, reflective optics located at the output of the lighting device, the planar surface with solid state light emitters located at the entrance to the reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a first group of solid state light emitters, said first group including light emitting diodes energized by an alternating current (AC) drive voltage, a second group of solid state light emitters, said second group including light emitting diodes energized by a direct current (DC) drive voltage, a housing configured to supply a 120 volt AC (60 Hertz) input signal to the base of the lighting device, electronics to activate the solid state light emitters, wherein one channel of the electronics may be configured as a AC-to-AC converter to apply the appropriate AC voltage(s) and drive currents to the AC driven LEDs, a second channel of the electronics to activate the solid state light emitters, wherein said second channel of the electronics may be configured as a AC-to-DC converter to apply the appropriate DC voltage(s) and drive currents to the DC driven LEDs, the solid state light emitters mounted on a planar surface, reflective optics located at the output of the lighting device, the planar surface with solid state light emitters located at the entrance to the reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, said solid state light emitters including a plurality of individual red, green, and blue light emitting diodes mounted on a common planar surface, reflective optics located at the output of the lighting device, said planar surface with solid state light emitters located at the entrance to said reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a first group of solid state light emitters, said first group including light emitting diodes energized by an direct current (DC) voltage with a color temperature in the range of 2800 to 3200 degrees Kelvin and a luminous flux greater than 650 lumens, a second group of solid state light emitters, said second group including light emitting diodes energized by a direct current (DC) voltage with a color temperature in the range of 5800 to 6200 degrees Kelvin and a luminous flux greater than 650 lumens, a housing configured to supply a 120 volt AC (60 Hertz) input signal to the base of the lighting device, a first set of electronics to activate the first group of solid state light emitters, wherein the first set of the electronics may be configured as an AC-to-DC converter to apply the appropriate DC voltage(s) and drive currents to said first group of DC driven LEDs, a second set of electronics to activate the second group of solid state light emitters, wherein the second set of the electronics may be configured as an AC-to-DC converter to apply the appropriate DC voltage(s) and drive currents to said second group of DC driven LEDs, said first and second group of solid state light emitters mounted on a common planar surface, reflective optics located at the output of the lighting device, said planar surface with solid state light emitters located at the entrance to said reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, said solid state light emitters mounted on a planar surface, reflective optics located at the output of the lighting device, said reflective optics partially filled with a polymer material, said planar surface with solid state light emitters located at the entrance to said reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising, a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, said solid state light emitters mounted on a planar surface, reflective optics located at the output of the lighting device, said planar surface with solid state light emitters located proximate to the focal plane of said reflective optics, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising, a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, said group of solid state light emitters mounted on a concave surface, and an encapsulating housing enclosing the solid state light emitters and the activating electronics with a shape and form factor substantially equivalent to the American National Standards Institute (ANSI) PAR30, PAR 38, R20 or MR16 lighting device structure.

Another embodiment of the present invention describes a lighting device for generating diffuse white light comprising, a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, said group of solid state light emitters mounted on a convex surface, and an encapsulating housing enclosing the solid state light emitters and the activating electronics with a shape and form factor substantially equivalent to the American National Standards Institute (ANSI) PAR30, PAR 38, R20 or MR16 lighting device structure.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a schematic representation of one embodiment of the present invention depicting a white light LED device configured for direct replacement of existing incandescent devices categorized by the American National Standards Institute (ANSI) as having part number PAR30.

FIG. 1A shows a breakout of the components shown fully integrated in FIG. 1.

FIG. 2 shows a schematic representation of the Light Emitting Diode (LED) array device.

FIG. 3 shows a schematic representation of a first outer horn-shaped reflector with an inner nested horn-shaped reflector with a shallower horn angle.

FIG. 3A shows a side view of the reflector depicted in FIG. 3.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to lighting devices, and more particularly to white light LED-based lighting devices with high luminous optical output configured for energy efficient lumen-for-lumen replacement of existing incandescent lighting devices. In the context of the present invention the phrase “energy efficient lumen-for-lumen replacement” refers to white light LED-based lighting devices which consume less electrical energy than the incandescent lighting devices they are intended to replace, while simultaneously producing at least the same, if not more, luminous optical output.

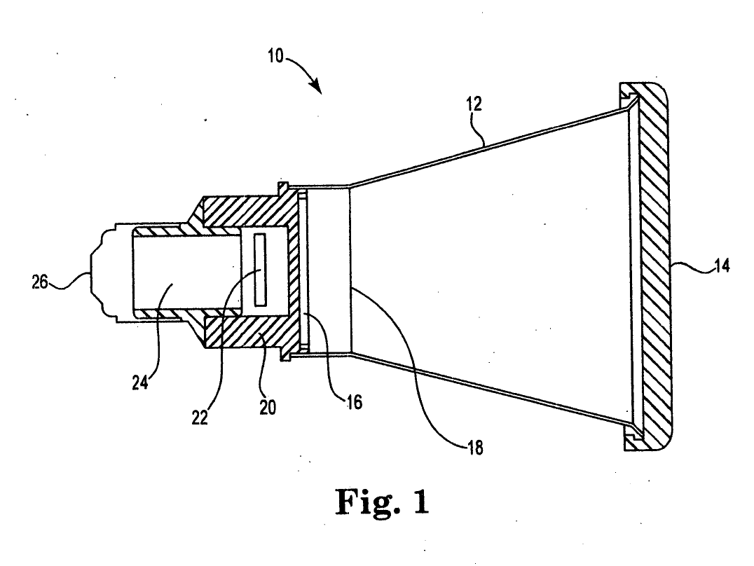

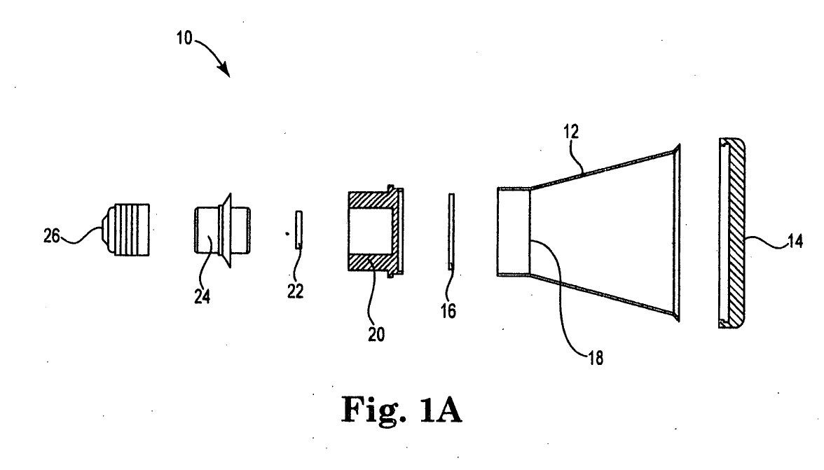

One embodiment of a white light LED device 10 in accordance with the present invention is depicted schematically in FIG. 1. Incandescent light bulb devices with the shape depicted in FIG. 1 have generally been categorized by the American National Standards Institute (ANSI) as having part number PAR 30. A break out of the components that comprise the white light LED device 10 depicted in FIG. 1, are shown in FIG. 1A, and it will be convenient to numerically label the components in the two figures consistently.

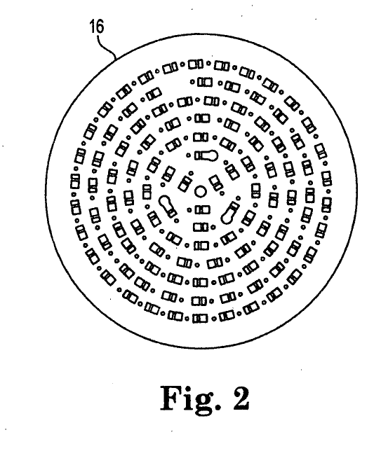

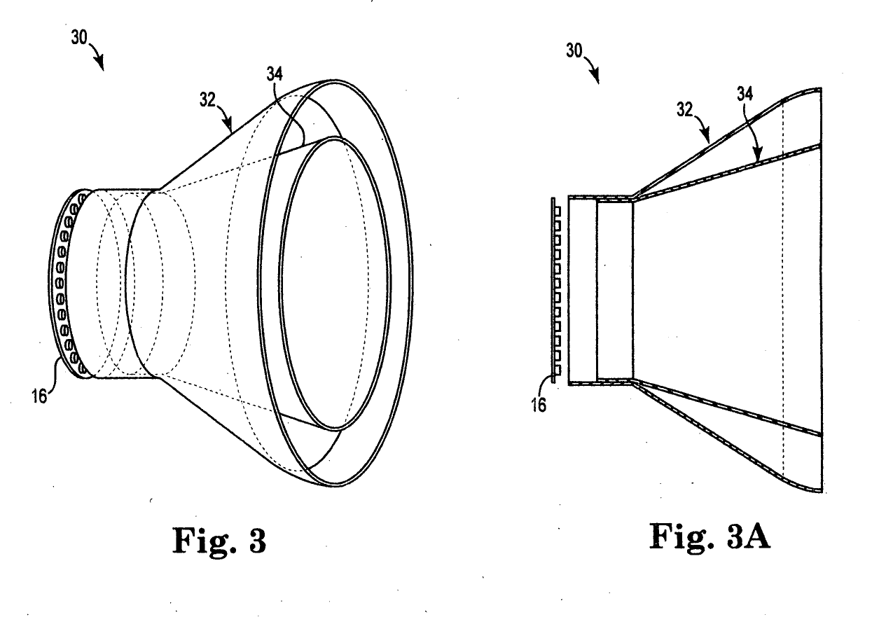

As shown in FIG. 1, the dominant physical structure is the horn-shaped optical reflector 12 with diffusing element 14 attached thereto. The optical reflector 12 may be fabricated from a metal or metal-like material, polished on its' inner surface for high reflectivity, or a plastic material coated on its' inner surface with a metallic film yielding a high reflection co-efficient optimally approaching 90% or better. In one embodiment of the present invention, an LED array 16 (shown in FIG. 2) is located proximate to the entrance aperture 18 of the optical reflector 12. Light emitting diodes typically have optical radiation that spans a viewing angle on the order of 120 degrees (+1-60 degrees from head-on to its' surface). Given this, it is important that the LED array 16 is located proximate to the entrance aperture 18 of the optical reflector 12, and the diameter and horn angle Θ of the optical reflector 12 is sufficient to capture a large fraction of the light emanating from the LED array 16.

One shortcoming of prior art LED lighting devices concerns “hot spots” or its counterpart “shadows” as an illumination device. In a preferred embodiment of the present invention, the geometrical relationship between the diameter of the LED array 16 (Φ_{LED}), the entrance aperture diameter and horn-angle Θ of the optical reflector 12, and the spacing between the surface of the LED array 16 and the entrance aperture 18 of the optical reflector 12 are all simultaneously chosen to ensure that optical radiation emanating from the LEDs at angles greater than 30° reflect at least once off the inner surface of the optical reflector 12. In this geometrical configuration, the optical reflector 12 behaves as an optical mixer to simultaneously smooth out what might other wise be hot spots and/or projected shadows. In addition to this, with a horn angle Θ on the order of 15 degrees, the optical reflector 12 may increase the projected light output in the far field (say, 10 to 15 feet from the white light LED device 10) by a factor 4 to 5× over the case with no reflector at all. This preferred embodiment satisfies the general requirements for both residential and commercial applications—sufficient optical energy delivered for illumination of objects over reasonable distances with no hot-spots or shadows.

With reference to FIG. 2, the LED array 16 may be comprised of a plurality of individual discrete LEDs adhered to a common planar substrate material. The LEDs may be of a similar type, for example same color temperature and power consumption, or the LEDs may be a mixture of different color temperature and/or power levels to customize and/or modify the output characteristics of the white light LED device 10. In one embodiment of the present invention, each discrete LED may be individually driven by a unique electrical activation signal (from the electrical driver board 22) or groups of LEDs may be “ganged” together and driven by a common electrical activation signal. In this configuration the following embodiments can be derived therefrom:
1) By utilizing a plurality of discrete LEDs of different color temperatures with individualized electrical activation signals, by varying the ratio of the electrical activation signals, the resultant color temperature at the output of the white light LED device 10 can be modified thereby by weighted “color mixing”.
2) By utilizing a plurality of discrete LEDs with individualized electrical activation signals, the luminous optical output of the white light LED device 10 can be modified by varying the fraction of activating available LEDs. For example, a traditional three-way lighting device could be enabled in this embodiment by external command to sequentially activate 25%, 50%, or 100% of the available LEDs.
3) The electrical driver board 22 may be configured to accept remote infrared commands to vary the activation levels to the individual LEDs. In this embodiment, both of the options defined above could be realized by a homeowner, for example, with a hand-held remote control device to either vary the color temperature or light output level of the white light LED device 10.

Returning to FIG. 1, for thermal management the LED array 16 may be in direct mechanical contact with heat sink assembly 20. The heat sink assembly 20 may be a passive metal or metal-like like material or an active device such as a thermo-electric cooler, commonly referred to as a Peltier cooler. In the case of an active heat sink assembly 20, the electrical power would be supplied by the electrical driver board 22. The electrical driver board 22 is isolated from the external electrical connector 26 which screws into a standard light bulb socket by electrical insulating device 24.

Heat sink assembly 20 may also include air vents or corrugate fins to increase the effective surface area to conduct or transfer outwardly heat generated from within the white light LED device 10. Electrical driver board 22 may have individual electronic components which are designed to be energized by an alternating (AC) or direct current (DC) voltage. In one embodiment of the present invention, electrical driver board 22 may include the necessary electronic components to convert the standard 120 volt AC (60 Hertz) signal to a direct current (DC) voltage appropriate for direct current driven LED's mounted on LED array 16.

Electrical driver board 22 may also include the appropriate electronic components to alter the luminous flux output of the LED's (commonly measured in units of lumens) and also modify the so-called color temperature of the white light LED device 10. The color temperature, commonly stated in units of degrees Kelvin, is a measure of the peak wavelength of light emitted from a radiating body. It is commonplace in the light bulb industry to refer to incandescent white light devices that have a color temperature in the range of 2800 to 3200 degrees Kelvin as being a “warm” color, whereas compact fluorescent lighting devices which typically have a color temperature in the range of 5800 to 6200 degrees Kelvin are referred to as being a “cool” color.

Electrical driver board 22 may alter the color temperature of white light LED device 10 by varying the ratio of the steady state direct current (DC) voltages to the individual blue light emitting diodes. For example, to generate a more “warm” color in the range of 2800 to 3200 degrees Kelvin, the electronic components on circuit board 22 may be chosen to deliver slightly more current to the warm LEDs than to the cool LED's. Similarly, to generate a more “cool” color similar to a compact fluorescent bulb, the electronic components on circuit board 22 may be chosen to deliver slightly more current to the cool LEDs than to the warm LED. In one embodiment of the present invention, the electronic components on circuit board 22 may be configured to receive a remote command via a wireless RF link or equivalent means, to alter the current to individual blue LED's. Given this, both the luminous flux output (measured in Lumens) of the white light LED device 10 and the color temperature of the white light LED device 10 may be modified via remote control by varying the amplitude and ratio of the currents to the individual warm and cool blue LED's. Diffusing surface 14 may consist of a frosted glass, plastic, or opal like material such that the light emanating from diffusing surface 14 appears uniformly distributed over the surface with no apparent bright spots.

In another embodiment of the present invention, the LED devices mounted on circuit board 22 may be compatible with an alternating current (AC) drive voltage. In this configuration, circuit board 22 may be configured to accept a 120-volt AC (60 Hertz) input signal and convert that signal to an AC signal appropriate for the individual LEDs mounted thereon.

In another embodiment of the present invention, the LED devices mounted on the LED array 16 may be a mixture of some LEDs compatible with a direct current (DC) drive voltage and other LED devices designed to be driven by an alternating current (AC) drive voltage. In this configuration, circuit board 22 may be configured to supply both the appropriate AC and DC drive voltages to the respective AC and DC LED devices.

In an alternative embodiment of the present invention, the LED devices may be mounted on either a concave or convex surface and with (or without) the optical reflector 12 shown in FIG. 1. By varying the shape of the LED array 16 surface from planar to either concave or convex, the overall angular distribution of light emanating from the white light LED device 10 can be varied accordingly. For example, by conceptually deforming the LED array 16 surface from planar to slightly concave may transform the light output to a narrower beam angle (i.e., transitioning the white light LED device 10 from a flood to more of a spot illuminator). Conversely, by conceptually deforming the LED array 16 surface from planar to slightly convex, may transform the light output to a wider beam angle. Taken to one extreme, the convex LED array 16 surface may be a hemispherical shape with a light output that spans 180 degrees or more (in this configuration, it may be advantageous that the white light LED device 10 has no reflector at all).

In yet another embodiment of the present invention, the optical reflector 12 shown in FIG. 1 may be partially or wholly filled with a polymer material. In this embodiment, the polymer material may be in direct physical contact, and/or chemically bonded to the LEDs and function as a moisture and water barrier thereto. The polymer may also function as a diffusing agent, but in all cases it is desirable that the polymer material be partially transparent at visible wavelengths. Candidate polymer materials may include acrylic polymers or copolymers including polymethyl methacrylate.

The polymer material may also have a fluorescent or phosphorescent material dispersed throughout. In this configuration, it may be possible to alter the light output color.

The present invention should not be considered limited to the particular examples described above, but rather should be understood to cover all aspects of the invention as fairly set out in the attached claims. Various modifications to the shape and form factors described above, equivalent processes to supplying the appropriate drive voltages to the LEDs, as well as numerous structures to which the present invention may be applicable will be readily apparent to those of skill in the art to which the present invention is directed upon review of the present specification. The following claims are intended to cover such modifications and devices.

I claim:

1. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said solid state light emitters mounted on a planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

2. The device of claim 1 wherein the group of solid state emitters comprises a blue light emitting diode with encapsulated phosphor capable of producing diffuse white light with a color temperature in the range of 2800 to 3200 degrees Kelvin and a luminous flux greater than 650 lumens.

3. The device of claim 1 wherein the group of solid state emitters comprises a blue light emitting diode with encapsulated phosphor capable of producing diffuse white light with a color temperature in the range of 5800 to 6200 degrees Kelvin and a luminous flux greater than 650 lumens.

4. The device of claim 2 wherein the diffuse white light color temperature and luminous flux can be modified by varying the ratio of the steady state direct current (DC) voltages to the individual blue light emitting diodes.

5. The device of claim 4 wherein the diffuse white light color temperature and luminous flux can be continuously modified by remote control.

6. The device of claim 1 wherein the encapsulating housing includes a diffusing element on its end face.

7. The device of claim 1 wherein the encapsulating housing includes a reflective element on its inboard surface excluding the end face.

8. The device of claim 1 wherein the encapsulating housing includes air vents.

9. The device of claim 1 wherein the solid state light emitters are in mechanical contact with a heat sinking element.

10. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs;
said solid state light emitters mounted on a planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

11. The device of claim 10 wherein the group of solid state emitters comprises a blue light emitting diode with encapsulated phosphor capable of producing diffuse white light with a color temperature in the range of 2800 to 3200 degrees Kelvin and a luminous flux greater than 650 lumens.

12. The device of claim 10 wherein the group of solid state emitters comprises a blue light emitting diode with encapsulated phosphor capable of producing diffuse white light with a color temperature in the range of 5800 to 6200 degrees Kelvin and a luminous flux greater than 650 lumens.

13. The device of claim 11 wherein the diffuse white light color temperature and luminous flux can be modified by varying the ratio of the steady state direct current (DC) voltages to the individual blue light emitting diodes.

14. The device of claim 13 wherein the diffuse white light color temperature and luminous flux can be continuously modified by remote control.

15. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs;
said solid state light emitters mounted on a planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

16. The device of claim 15 wherein the group of solid state emitters comprises a plurality of blue light emitting diode capable of producing diffuse white light with a color temperature in the range of 2800 to 3200 degrees Kelvin and a luminous flux greater than 650 lumens.

17. The device of claim 15 wherein the group of solid state emitters comprises a plurality of blue light emitting diode capable of producing diffuse white light with a color temperature in the range of 5800 to 6200 degrees Kelvin and a luminous flux greater than 650 lumens.

18. The device of claim 15 wherein the diffuse white light color temperature and luminous flux can be modified by varying the ratio of the steady state direct current (DC) voltages to the individual blue light emitting diodes.

19. The device of claim 18 wherein the diffuse white light color temperature and luminous flux can be continuously modified by remote control.

20. A lighting device for generating diffuse white light comprising:
a first group of solid state light emitters, said first group including light emitting diodes energized by an alternating current (AC) drive voltage;
a second group of solid state light emitters, said second group including light emitting diodes energized by a direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs;
said solid state light emitters mounted on a planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

21. The device of claim 20 wherein the group of solid state emitters comprises a plurality of blue light emitting diode capable of producing diffuse white light with a color temperature in the range of 2800 to 3200 degrees Kelvin and a luminous flux greater than 650 lumens.

22. The device of claim 20 wherein the group of solid state emitters comprises a plurality of blue light emitting diodes capable of producing diffuse white light with a color temperature in the range of 5800 to 6200 degrees Kelvin and a luminous flux greater than 650 lumens.

23. The device of claim 21 wherein the diffuse white light color temperature and luminous flux can be modified by varying the ratio of the steady state direct current (DC) voltages to the individual blue light emitting diodes.

24. The device of claim 23 wherein the diffuse white light color temperature and luminous flux can be continuously modified by remote control.

25. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said solid state light emitters including a plurality of individual red, green, and blue light emitting diodes mounted on a common planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

26. The device of claim 25 wherein the plurality of individual red, green, and blue light emitting diodes are mounted on a common planar surface with a diameter in the range of 25 millimeters to 30 millimeters.

27. The device of claim 26 wherein the total number of red, green, and blue light emitting diodes mounted on the common planar surface is in the range of 50 to 100.

28. The device of claim 25 wherein the common planar surface is placed between 5 to 10 millimeters from the entrance to the reflective optics.

29. The device of claim 25 wherein the entrance aperture of the reflective optics is between 40 to 50 millimeters.

30. The device of claim 29 wherein the reflective optics is in the shape of a horn with an exit diameter between 75 to 100 millimeters.

31. A lighting device for generating diffuse white light comprising:
a first group of solid state light emitters, said first group including light emitting diodes energized by an direct current (DC) voltage with a color temperature in the range of 2800 to 3200 degrees Kelvin and a luminous flux greater than 650 lumens;
a second group of solid state light emitters, said second group including light emitting diodes energized by a direct current (DC) voltage with a color temperature in the range of 5800 to 6200 degrees Kelvin and a luminous flux greater than 650 lumens;
a housing configured to supply a 120 volt AC (60 Hertz) input signal to the base of the lighting device;
a first set of electronics to activate the first group of solid state light emitters, wherein the first set of the electronics may be configured as an AC-to-DC converter to apply the appropriate DC voltage(s) and drive currents to said first group of DC driven LEDs;
a second set of electronics to activate the second group of solid state light emitters, wherein the second set of the electronics may be configured as an AC-to-DC converter to apply the appropriate DC voltage(s) and drive currents to said second group of DC driven LEDs;
said first and second group of solid state light emitters mounted on a common planar surface;
reflective optics located at the output of the lighting device;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

32. The device of claim 31 wherein the diffuse white light color temperature and luminous flux can be modified in the range of 2800 degrees Kelvin to 6,000 degrees Kelvin by varying the ratio of the steady state direct current (DC) voltages to the first and second group of solid state light emitters.

33. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said solid state light emitters mounted on a planar surface;
reflective optics located at the output of the lighting device;
said reflective optics partially filled with a polymer material;
said planar surface with solid state light emitters located at the entrance to said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

34. The device of claim 33 wherein the polymer material is an acrylic polymer or copolymer.

35. The device of claim 34 wherein the acrylic polymer is polymethyl methacrylate

36. The device of claim 34 wherein the acrylic polymer or copolymer is embedded with a phosphorescent material.

37. The device of claim 33 wherein the acrylic polymer or copolymer is in direct contact with the solid state light emitters.

38. The device of claim 37 wherein the acrylic polymer or copolymer is chemically adhered to the solid state light emitters.

39. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said solid state light emitters mounted on a planar surface;
reflective optics located at the output of the lighting device;
said planar surface with solid state light emitters located proximate to the focal plane of said reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

40. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said group of solid state light emitters mounted on a concave surface; and
an encapsulating housing enclosing the solid state light emitters and the activating electronics with a shape and form factor substantially equivalent to the American National Standards Institute (ANSI) PAR30, PAR 38, R20 or MR16 lighting device structure.

41. The device of claim 40 wherein the concave surface has a central radius of curvature in the range of 100 millimeters to 250 millimeters.

42. The device of claim 40 wherein the concave surface has a central radius of curvature in the range of 250 millimeters to 1,000 millimeters.

43. The device of claim 40 wherein the concave surface is elliptical.

44. The device of claim 40 wherein the concave surface is parabolic.

45. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said group of solid state light emitters mounted on a convex surface; and
an encapsulating housing enclosing the solid state light emitters and the activating electronics with a shape and form factor substantially equivalent to the American National Standards Institute (ANSI) PAR30, PAR 38, R20 or MR16 lighting device structure.

46. The device of claim 40 wherein the convex surface has a central radius of curvature in the range of 100 millimeters to 250 millimeters.

47. The device of claim 40 wherein the convex surface has a central radius of curvature in the range of 250 millimeters to 1,000 millimeters.

48. The device of claim 40 wherein the convex surface is elliptical.

49. The device of claim 40 wherein the convex surface is parabolic.

50. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
said solid state light emitters mounted on a planar surface;
a first reflective optic located at the output of the lighting device;
said planar surface with solid state light emitters located at the entrance to said reflective optics;
a second reflective optic nested within the said first reflective optics; and
an encapsulating housing enclosing the solid state light emitters and the activating electronics with a shape and form factor substantially equivalent to the American National Standards Institute (ANSI) PAR30, PAR 38, R20 or MR16 lighting device structure.

51. The device of claim 50 wherein the first reflective optic is horn-shaped with a horn angle Θ₁ of approximately 30 degrees.

52. The device of claim 50 wherein the second reflective optic is horn-shaped with a horn angle Θ₂ of approximately 15 degrees.
